(19) United States
(12) Patent Application Publication
(10) Pub. No.: US 2016/0203454 A1
(43) Pub. Date: Jul. 14, 2016

(54) INFORMATION PROCESSING APPARATUS AND METHOD FOR RECOGNIZING SPECIFIC PERSON BY THE SAME

(71) Applicant: TOSHIBA TEC KABUSHIKI KAISHA, Tokyo (JP)

(72) Inventor: Takahiro Kogoshi, Sunto (JP)

(21) Appl. No.: 14/993,182

(22) Filed: Jan. 12, 2016

(30) Foreign Application Priority Data
Jan. 13, 2015 (JP) 2015-004325

(51) Int. Cl. G06Q 20/20; G06K 9/62; G06K 9/00; G06K 9/46

(52) U.S. Cl. CPC G06Q 20/206; G06K 9/46; G06K 9/6215; G06K 9/00268; G06K 9/00288; G06K 9/00255

(57) ABSTRACT

An information processing apparatus comprises an acquisition module configured to acquire a plurality of feature amount representing the features of a person who enters a store from an image captured by photographing the person who enters the store, a similarity degree calculation module configured to compare each of the plurality of feature amount acquired by the acquisition module with pre-stored corresponding feature amount of a specific individual to calculate a similarity degree therebetween and a notification module configured to output a notice if the similarity degree between one or all of the plurality of feature amount acquired by the acquisition module and pre-stored corresponding feature amount of the specific individual is higher than a specific threshold value.

### CROSS-REFERENCE TO RELATED APPLICATION

This application is based upon and claims the benefit of priority from Japanese Patent Application No. 2015-004325, filed Jan. 13, 2015, the entire contents of which are incorporated herein by reference.

### FIELD

Embodiments described herein generally relate to an information processing apparatus and a method for recognizing a specific person by the information processing apparatus.

### BACKGROUND

In a retail store such as a convenience store, the surveillance operation is carried out with a camera to monitor the inside of the store. A technology has been proposed in which facial feature information representing the facial features of a person extracted from an image data obtained by capturing the image of a person with a camera is compared with facial feature information of individuals registered in advance to recognize or specify an unfavorable person.

However, according to the conventional technology, it is required that at least a part of a face is photographed, but if a face cannot be photographed, then because of the absence of facial feature information, it cannot be determined whether or not a person who enters a store is an unfavorable person. Thus, in the conventional technologies, it is limited to recognize a person who enters the store in such circumstances described above.

### DESCRIPTION OF THE DRAWINGS

FIG. 1 is a schematic diagram illustrating a store system according to an embodiment;

FIG. 2 is a block diagram exemplifying the hardware structure of a store server;

FIG. 3 is a block diagram exemplifying the functional structure of the store server;

FIG. 4 is a diagram illustrating a method for estimating the height of a person; and

FIG. 5 is a flowchart exemplifying the procedures of a notification processing.

### DETAILED DESCRIPTION

In accordance with an embodiment, an information processing apparatus comprises an acquisition module, a similarity degree calculation module and a notification module. The acquisition module acquires a plurality of feature amount representing the features of a person who enters a store from an image captured by photographing the person who enters the store. The similarity degree calculation module compares each feature amount acquired by the acquisition module with pre-stored corresponding feature amount of a specific individual to calculate a similarity degree therebetween. The notification module outputs a notice if the similarity degree between one or all of the plurality of feature amount acquired by the acquisition module and pre-stored corresponding feature amount of the specific individual is higher than a specific threshold value.

The information processing apparatus according to the present embodiment is described below by taking a store system introduced in a store such as a convenience store as an example.

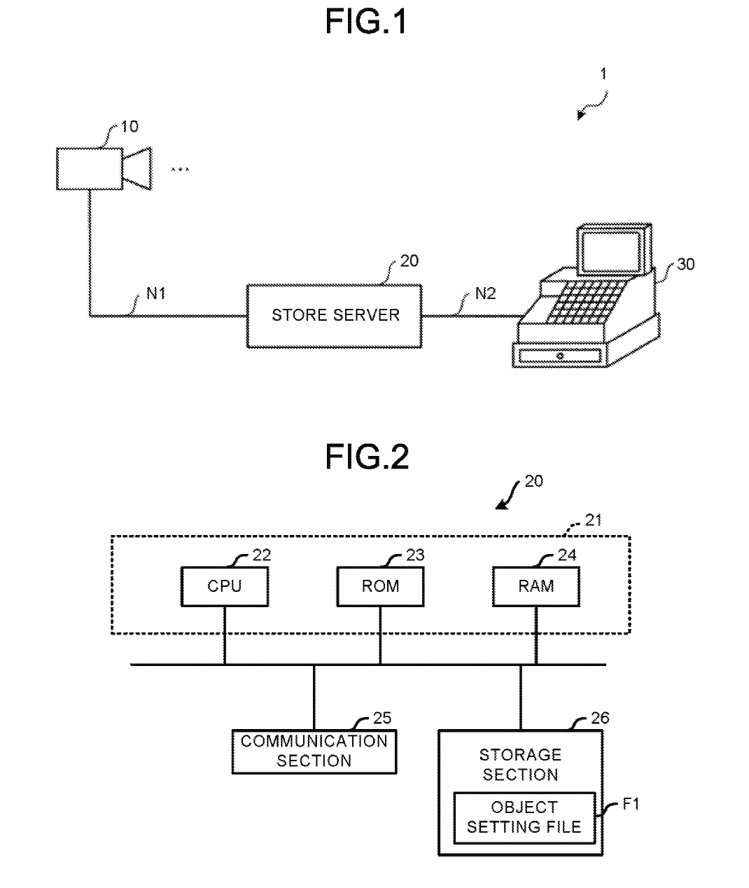

FIG. 1 is a schematic diagram illustrating a store system 1 according to the present embodiment. As shown in FIG. 1, the store system 1 comprises a camera 10, a store server 20 and a POS terminal 30. The camera 10 and the store server 20 are connected with each other via a network N1. The store server 20 and the POS terminal 30 are connected with each other via a network N2.

The camera 10 is an image capturing device equipped with an image capturing element such as a CCD (Charge Coupled Device) or a CMOS (Complementary Metal Oxide Semiconductor) The camera 10 is mainly arranged inside the store to send moving images (frame images) captured at a frame rate of, for example, 30 fps, to the POS terminal 30 as captured images. No specific limitations are given to the arrangement positions or the number of the cameras 10. In the present embodiment, the camera 10 is arranged at a position at which the camera 10 can photograph the vicinity of the entrance of the store so that a customer who enters the store (person who comes to the store) can be photographed from the front side.

The store server 20 corresponds to the information processing apparatus of the present embodiment. The store server 20 collectively manages data received from the POS terminal 30 and other data to carry out a sales management, a stock management and an expense management for the store. Further, the store server 20 detects a customer according to the images captured by the camera 10 and outputs a notice if the customer is an individual pre-registered as an alert target. The store server 20 will be described later in detail.

The POS terminal 30 locates at a settlement place in the store to carry out registration and settlement of commodities purchased by a customer. Specifically, the POS terminal 30 records the commodity code and the purchase quantity of each commodity purchased by the customer in a sales master file (not shown) to execute a sales-registration of each commodity.

FIG. 2 is a block diagram exemplifying the hardware structure of the store server 20. The store server 20 comprises a microcomputer 21 functioning as an information processing section for carrying out an information processing. The microcomputer 21 is mainly composed of a CPU (Central Processing Unit) 22, a ROM (Read Only Memory) 23 and a RAM (Random Access Memory) 24. The ROM 23 stores the various programs that can be executed by the CPU 22. The RAM 24 is a main storage device of the POS terminal 30.

Further, a communication section 25 is connected with the CPU 22 via various input/output circuits (not shown). The communication section 25 is an interface through which a data communication with an external device is carried out. In the present embodiment, the data communication is carried out between the communication section 25 and each camera 10 or the POS terminal 30 arranged in the store.

The CPU 22 is further connected with a storage section 26, for example, an HDD (Hard Disk Drive) or an SSD (Solid State Drive). The storage section 26 stores the various programs and files executable by the CPU 22. The programs and files stored in the storage section 26 are all or partially copied on the RAM 24 when the store server 20 is activated to be executed by the CPU 22. An object setting file F1 is also stored in the storage section 26.

Various features of a person who is an alert target are registered in the object setting file F1 as feature information. No limitations are given to the features set as feature information. For example, the feature information includes a first feature amount representing the face image of a person who is an alert target and the features of the face image. Information representing the contour and the shape of each part (e.g. the nose, the eyes) of the face and the relationship of positions of the parts on the face are set in the first feature.

Further, the feature information also includes a second feature amount representing the features of, for example, the clothing worn by the person who is an alert target. Information representing the shape and surface features (color and material) of the clothing and shoes worn by the person is set in the second feature amount. Further, if the person wears or has an accessory such as a bag, a hat, glasses, sun glasses, a mask and the like, then information representing the shape and surface features (e.g. color and material) of the accessory is set in the second feature amount.

Further, the feature information includes physical constitution information representing the physical constitution of the person who is an alert target. Information representing a height range of the person (e.g. 165-175 cm) and an obese figure or skinny figure is set in the physical constitution information.

The object setting file F1 stores, for each person who is an alert target, one or all of the first feature amount, the second feature amount and the physical constitution information relating to the each person (alert target) as the feature information. Further, no limitations are given to the individual who is set as an alert target. For example, the alert target may be a person requiring a special attention or an important person who comes to the store before or a person wanted by a third agency such as a police office.

The data structure of the object setting file F1 is not limited to that shown in FIG. 2. For example, the object setting file F1 may store comment information in association with the feature information of each registered individual. In this case, the name of a corresponding registered individual and the reason why the registered individual is an alert target can be set in the comment information.

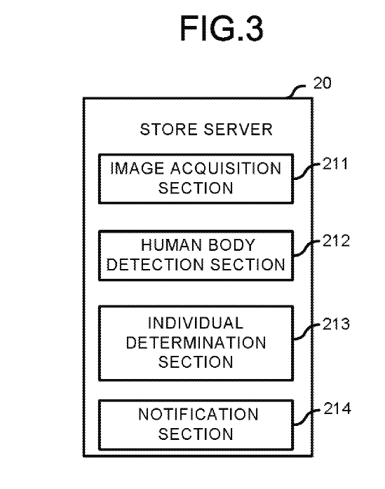

Next, the functional structure of the store server 20 is described with reference to the FIG. 3. FIG. 3 is a block diagram exemplifying the functional structure of the store server 20. The store server 20 functions as an image acquisition section 211, a human body detection section 212, an individual determination section 213 and a notification section 214 through the cooperation of the CPU 22 with the programs stored in the ROM 23 or the storage section 26.

The image acquisition section 211 sequentially acquires, via the communication section 25, images captured by the camera 10. Further, the image acquisition section 211 stores the images acquired for a specific period of time in the RAM 24 or the storage section 26. No limitations are given to the timing at which the image acquisition section 211 acquires the image captured by the camera 10. For example, the image acquisition section 211 may regularly acquire the images captured by the camera 10. Further, in a case in which a human body sensor (e.g. an infrared sensor) is arranged at the entrance of the store, the image acquisition section 211 may start the acquisition of the images captured by the camera 10 according to the detection result of the human body sensor.

The human body detection section 212 detects a human body area representing the body of a customer according to the image acquired by the image acquisition section 211. A human body area can be detected with the use of a well-known technology and is not limited to be detected with a specific technology. For example, the human body detection section 212 may detect an area of which the changes are detected in a series of captured images successive in time as a human body area. Further, the human body detection section 212 may detect the area in which a moving body is detected in a series of captured images successive in time as a human body area.

The individual determination section 213 determines whether or not the person (customer) represented by the human body area detected by the human body detection section 212 is an individual who is registered in the object setting file F1 as an alert target.

Further, the individual determination section 213 functions as the acquisition module according to the present embodiment. Specifically, the individual determination section 213 acquires various kinds of feature information from a captured image and a human body area to determine the individual represented by the human body area. For example, the individual determination section 213 detects the face image of a customer according to a human body area detected by the human body detection section 212 and acquires the features of the face image as a first feature amount. The first feature amount can be acquired with the use of a well-known technology and is not limited to be acquired with a specific technology.

Further, the individual determination section 213 acquires a second feature amount from the clothing worn by the customer represented by the human body area. The individual determination section 213 determines whether or not the customer represented by the human body area has an accessory such as a bag or glasses, and acquires the second feature amount of the accessory if it is determined that the customer has the accessory. Further, the second feature amount can be acquired with the use of a well-known technology and is not limited to be acquired with a specific technology.

Further, the individual determination section 213 acquires, according to the shape and size of a human body area contained in a captured image, physical constitution information representing the physical constitution (e.g. height) of the customer represented by the human body area. The physical constitution information can be acquired with the use of a well-known technology and is not limited to be acquired with a specific technology.

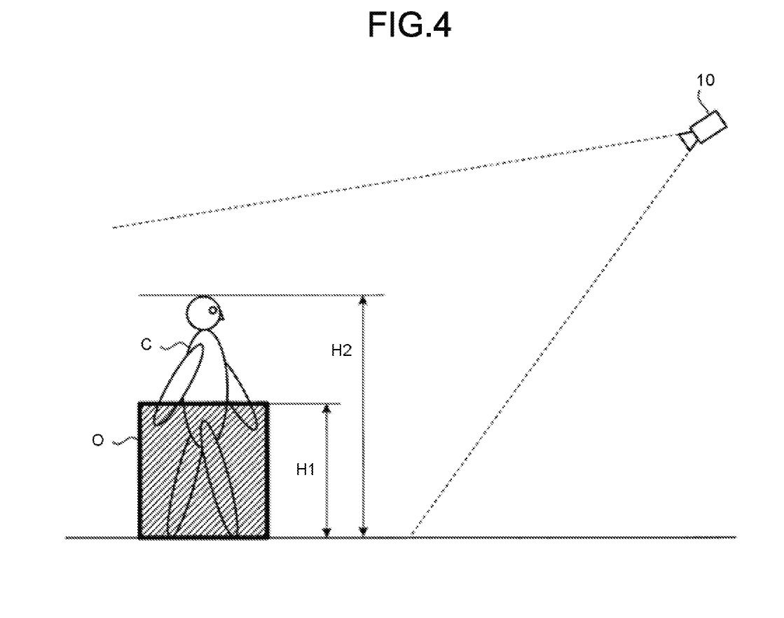

For example, the height of the individual represented by the human body area can be estimated according to the result of the comparison of the height of a reference object presented in the captured image with that of a human body area. FIG. 4 is a diagram illustrating a method for estimating the height of a person. The relationship between a reference object O and the camera 10 photographing the vicinity of the reference object O is illustrated in FIG. 4. The reference object O located near the entrance of the store has a reference height of, for example, 1 m. The reference object O may be, for example, furniture in the store such as a commodity shelf, a security gate or the like.

In FIG. 4, if a customer C is present near the reference object O, the camera 10 photographs the reference object O and the customer C. In the individual determination section 213, the height of the customer C is acquired (estimated) according to an image captured by photographing the reference object O and the customer C. Specifically, based on the actual height of the reference object O, the individual determination section 213 detects (estimates) the height of the customer C according to the ratio of a height H1 of the reference object O to a height H2 of the customer C (individual area) contained in the captured image. Further, the human body sensor may be arranged at the reference object O.

Further, the individual determination section 213 functions as the similarity degree calculation module according to the present embodiment. Specifically, the individual determination section 213 acquires the feature information of the customer from the captured image to compare the acquired feature information with the feature information of each individual registered in the object setting file F1 (hereinafter referred to as a registered individual).

For example, the individual determination section 213 compares the first feature amount of the customer acquired from the captured image with that of each registered individual to calculate the similarity degree therebetween. If a registered individual whose similarity degree is higher than a specific threshold value exists, then the individual determination section 213 determines that the first feature amount of the customer who enters the store is matched with that of the registered individual. Additionally, a well-known technology such as a facial authentication technology can be used to carry out the comparison of the first feature amount (face image) described above.

Further, the individual determination section 213 compares the second feature amount of the customer acquired from the captured image (human body area) with that of each registered individual to calculate the similarity degree therebetween. If there is a registered individual whose similarity degree is higher than a specific threshold value, then the individual determination section 213 determines that the second feature amount of the customer is matched with that of the registered individual. A well-known technology can be used to carry out the comparison of the second feature amount (clothing) described above.

Further, the individual determination section 213 compares the physical constitution information of the customer acquired from the captured image (human body area) with that of each registered individual. If a registered individual whose physical constitution information is matched with that of the customer, the individual determination section 213 sets the registered individual as a comparison target to be compared in first and second feature amounts with the customer.

Moreover, the individual determination section 213 determines whether or not the customer who enters the store is a person who is an alert target according to the results of the determination of the first feature amount, the second feature amount and the physical constitution information. For example, if it is determined that the first feature amount of the person who enters the store meets a condition of the first feature amount (face image) of a registered individual, the individual determination section 213 determines that the registered individual enters the store, i.e., the person is the registered individual. In other case, if it is determined that the second feature amount and the physical constitution information between the person who enters the store and a registered individual are respectively matched, the individual determination section 213 determines that the registered individual enters the store. Further, the determination criterion of whether or not a registered individual enters the store is not limited to the case (example) as described above in which whether or not apart of feature information is matched. For example, the individual determination section 213 may determine that a registered individual enters the store if all feature information between the person who enters the store and the registered individual are matched.

The notification section 214 functions as the notification module according to the present embodiment. If the individual determination section 213 determines that a registered individual enters the store, the notification section 214 notifies store clerks that the registered individual (alert target) enters the store. The notification method by the notification section 214 is not limited specifically and any notification manner can be adopted. For example, the notification section 214 turns on an indicator light or warning light arranged in the store to notify that a registered individual enters the store. Further, the notification section 214 causes the display (not shown) of the POS terminal 30 to display a notification screen to notify that a registered individual enters the store.

No limitations are given to the structure of the notification screen in a case in which the display of the POS terminal 30 is used to notify that a registered individual enters the store. For example, the notification section 214 may display a captured image acquired by the image acquisition section 211 or a face image extracted from the captured image on the notification screen. Further, the notification section 214 may display a face image extracted from the captured image and the face image (feature information) of a registered individual having the same first feature amount as the extracted face image on the notification screen in a comparable manner. In this case, the operator of the POS terminal 30 can confirm whether or not the person who enters the store is a person of an alert target by comparing the face images, and thus convenience for user or operator of the POS terminal 30 can be enhanced.

Further, in a case in which comment information is stored in association with the feature information, the notification section 214 may display the content of the comment information on the notification screen. For example, if the name of a registered individual and the reason why the registered individual becomes an alert target are set in the comment information, the operator of the POS terminal 30 can confirm the contents easily, and thus convenience for user or operator of the POS terminal 30 can be enhanced.

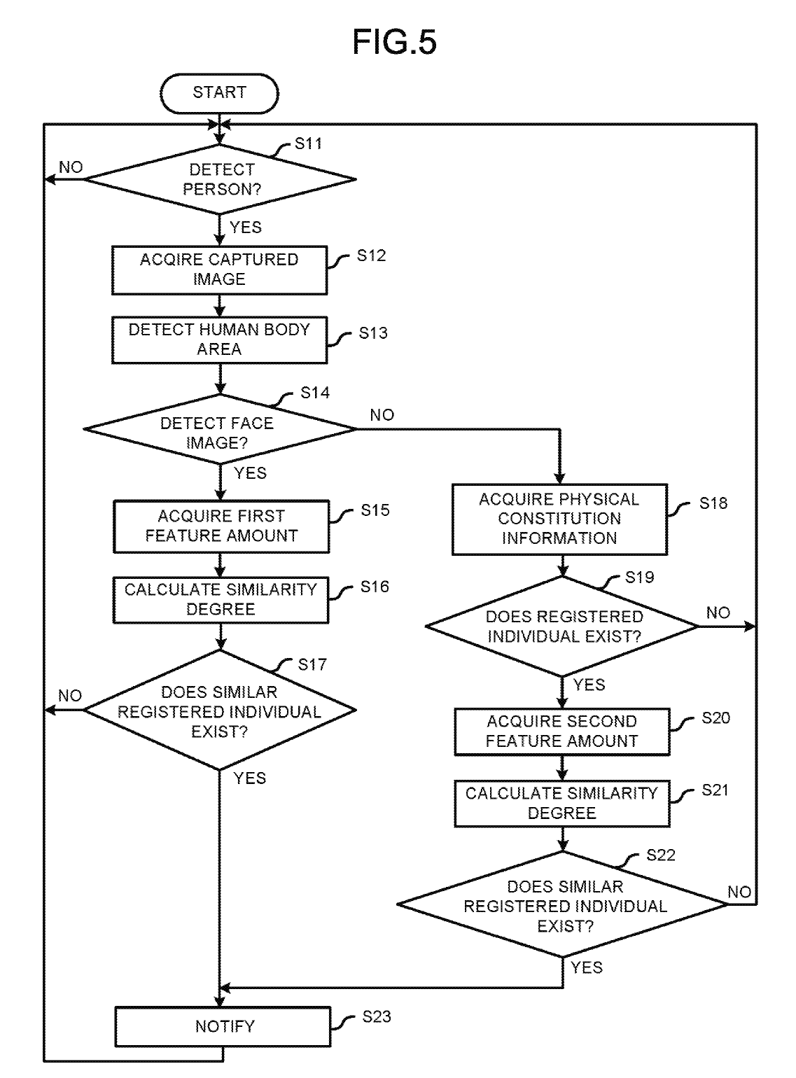

Hereinafter, a notification processing carried out by the store server 20 is described with reference to FIG. 5. FIG. 5 is a flowchart exemplifying the operations carried out by the store server 20 in a notification processing. In this processing, a case in which a captured image is acquired in response to the detection result of a human body sensor is described.

First, the image acquisition section 211 waits for until a customer (a person who comes to the store) is detected by the human body sensor arranged at the entrance of the store (Act S11: No). If the customer is detected by the human body sensor (Act S11: Yes), the image acquisition section 211 acquires, from the camera 10, a captured images (frame images) for a specific period of time (Act S12).

The human body detection section 212 detects the human body area in which the customer exists from the captured images acquired in Act S12. Sequentially, the individual determination section 213 attempts to detect a face image from the human body area detected in Act S13 (Act S14). If a face image is detected from the human body area (Act S14: Yes), the individual determination section 213 acquires the first feature amount of the customer from the detected face image (Act S15).

Then, the individual determination section 213 compares the first feature amount of the customer acquired in Act S15 with that of each registered individual to calculate the similarity degree therebetween (Act S16). Next, the individual determination section 213 determines whether or not there is a similarity degree greater than a threshold value within the calculated similarity degrees (Act S17).

If it is determined in Act S17 that there is a similarity degree greater than the threshold value (Act S17: Yes), the individual determination section 213 determines that the customer who comes to the store has the greatest similarity degree in the first feature amount to the registered individual and therefore the registered individual comes to the store, and then Act S23 is taken. If it is determined in Act S17 that there is no similarity degree greater than the threshold value (Act S17: No), then Act S11 is taken again.

Further, if no face image is detected in Act S14 (Act S14: No), then the individual determination section 213 acquires the physical constitution information (height) of the customer from the captured image (Act S18). Sequentially, the individual determination section 213 compares the physical constitution information of the customer acquired in Act S18 with that of each registered individual to determine whether or not there is a registered individual whose physical constitution information is matched with that of the customer (Act S19). If it is determined that there is no registered individual whose physical constitution information is matched with that of the customer (Act 519: No), Act S11 is taken again.

On the other hand, if it is determined in Act S19 that there is a registered individual whose physical constitution information is matched with that of the customer (Act S19: Yes), the individual determination section 213 sets the registered individual whose physical constitution information is matched with that of the customer as a comparison target. Further, the individual determination section 213 acquires the second feature amount of the customer from the captured image (Act S20). Then, the individual determination section 213 compares the second feature amount of the customer with that of each registered individual set as a comparison target to calculate the similarity degree therebetween (Act S21). Next, the individual determination section 213 determines whether or not there is a similarity degree greater than a threshold value within the calculated similarity degrees (Act S22).

If it is determined in Act S22 that there is a similarity degree greater than a threshold value (Act S22: Yes), the individual determination section 213 determines that the customer has the greatest similarity degree in the second feature amount to the registered individual and thus the registered customer comes to the store, and then Act S23 is taken. Further, if it is determined in Act S22 that there is no similarity degree greater than a threshold value (Act S22: No), Act S11 is taken again.

In the following Act S23, the notification section 214 notifies that an alert target comes to the store according to the result of the determination of the individual determination section 213 (Act S23), and Act S11 is taken again.

As stated above, in the present embodiment, the store server 20 determines whether or not a customer who comes to the store is an alert target according to a plurality of feature amount acquired from an image captured by photographing the customer. Moreover, if the customer is an alert target, the store server 20 notifies store clerks of the alert target (customer) who enters the store. In this way, in the store server 20, a customer can be recognized in diversified viewpoints, and thus the recognition for a customer (alert target) can be carried out more flexibly. Further, a notice is output if the customer is an alert target to urge store clerks to visually confirm the customer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, it is described in the foregoing embodiments that the store server 20 stores an object setting file F1; however, the present embodiment is not limited to this. The object setting file F1 may also be stored in an external device accessible by the store server 20.

Further, it is described in the foregoing embodiments that three feature amounts, i.e., a first feature amount, a second feature amount and physical constitution information, are acquired from an image captured by photographing a customer; however, other feature amount may be acquired. If other feature amount is acquired, other feature amount corresponding to an alert target is registered in the object setting file F1 beforehand.

Further, it is described in the foregoing embodiments that the three feature amounts are acquired from an image captured by photographing a customer; however, it is applicable that one or all of the feature information is registered in the object setting file F1 if the customer becomes an alert target.

Further, in the present embodiment, the information processing apparatus of the present invention is applied to the store server 20; however, it is not limited to the store server and the information processing apparatus of the present invention may also be applied to other apparatus.

The programs executed by each device according to the foregoing embodiments are previously assembled in the storage medium (e.g. the ROM or the storage section) of the device; however, the present invention is not limited to this. The programs may also be recorded and provided in a computer-readable recording medium as installable or executable files. The recording medium is, for example, a CD-ROM, a FD (flexible disk), a CD-R or a DVD (Digital Versatile Disk). Further, the storage medium is not limited to a medium independent from a computer or assembled in a system. For example, the storage medium may also be a storage medium which stores or temporarily stores a program transferred via an LAN or the Internet by downloading the program.

The programs executed by each device according to the foregoing embodiments may also be provided or delivered through a network such as the Internet.

What is claimed is:

1. An information processing apparatus, comprising
an acquisition module configured to acquire a plurality of feature amounts representing features of a person who enters a store from an image captured by photographing the person who enters the store;
a similarity degree calculation module configured to compare each of the plurality of feature amounts acquired by the acquisition module with pre-stored corresponding feature amount of a specific individual to calculate a similarity degree therebetween; and
a notification module configured to output a notice if the similarity degree between one or all of the plurality of feature amount acquired by the acquisition module and the pre-stored corresponding feature amount of the specific individual is higher than a specific threshold value.

2. The information processing apparatus according to claim 1, wherein the acquisition module acquires a first feature amount representing the facial feature of a person who enters the store, and the similarity degree calculation module compares the first feature amount acquired by the acquisition module with that of the specific individual.

3. The information processing apparatus according to claim 1, wherein the acquisition module acquires a second feature amount representing the feature of a clothing worn by the person who enters the store, and the similarity degree calculation module compares the second feature amount acquired by the acquisition module with that of the specific individual.

4. The information processing apparatus according to claim 2, wherein the acquisition module acquires a second feature amount representing the feature of a clothing worn by the person who enters the store, and the similarity degree calculation module compares the second feature amount acquired by the acquisition module with that of the specific individual.

5. The information processing apparatus according to claim 2, wherein
the acquisition module acquires, from the captured image, physical constitution information representing the physical constitution of the person who enters the store, and the similarity degree calculation module compares the physical constitution information acquired by the acquisition module with that of the specific individual and sets a specific individual whose physical constitution information is matched with the physical constitution information acquired by the acquisition module as a comparison target.

6. The information processing apparatus according to claim 3, wherein the acquisition module acquires, from the captured image, physical constitution information representing the physical constitution of the person who enters the store, and the similarity degree calculation module compares the physical constitution information acquired by the acquisition module with that of the specific individual and sets the specific individual whose physical constitution information is matched with the physical constitution information acquired by the acquisition module as a comparison target.

7. The information processing apparatus according to claim 5, wherein the acquisition module acquires the height of the person who enters the store presented in the captured image as the physical constitution information according to the height of a reference object presented in the captured image.

8. A method for identifying a specific person by an information processing apparatus, including:
acquiring a plurality of feature amount representing the features of a person who enters a store from an image captured by photographing the person who enters the store;
comparing each of the acquired plurality of feature amount with pre-stored feature amount corresponding to a specific individual to calculate a similarity degree therebetween; and
outputting a notice if the similarity degree between one or all of the plurality of feature amount acquired and pre-stored corresponding feature amount of the specific individual is higher than a specific threshold value.
